(19) United States
(12) Patent Application Publication
(10) Pub. No.: US 2011/0210927 A1
(43) Pub. Date: Sep. 1, 2011

(54) DISPLAY DEVICE WITH TOUCH SENSOR, TOUCH PANEL, METHOD OF DRIVING TOUCH PANEL, AND ELECTRONIC DEVICE

(75) Inventors: Hiroshi Mizuhashi, Kanagawa (JP); Takeo Koito, Kanagawa (JP); Shuji Hayashi, Aichi (JP)

(73) Assignee: SONY CORPORATION, Tokyo (JP)

(21) Appl. No.: 13/024,985

(22) Filed: Feb. 10, 2011

(30) Foreign Application Priority Data
Feb. 26, 2010 (JP) 2010-042801

(51) Int. Cl. G06F 3/041

(52) U.S. Cl. 345/173

(57) ABSTRACT

In one example embodiment, a display device includes a drive control section operatively coupled to a signal line and a display section. The signal line has a first voltage. In one example embodiment, the display section includes: (a) a touch detection element which outputs a touch voltage; and (b) an electrode which has a second voltage. In one example embodiment, the drive control section increases a potential difference between the first voltage and the second voltage before the touch detection element outputs the touch voltage.

### CROSS REFERENCES TO RELATED APPLICATIONS

The present application claims priority to Japanese Patent Application No. JP 2010-042801, filed in the Japanese Patent Office on Feb. 26, 2010 the entire contents of which is being incorporated herein by reference.

### BACKGROUND

In recent years, a display device in which a contact detection unit, which is a so-called touch panel, is mounted on a display device such as a liquid crystal display device, or the touch panel and the display device are integrated so as to display various button images and the like on that display device, thereby realizing information input in substitution for using typical mechanical buttons has attracted attention. In the display device including such a touch panel, because an input unit such as a keyboard, a mouse, and a keypad is not necessary, there is a tendency that the use of the display device is expanded in a portable information terminal such as a portable phone in addition to a computer.

There are several methods of the touch panel, and one of them is a method in which deflection of the touch panel generated by pressing force (touch) of a finger or the like is detected. To this method, for example, the touch panel (contact type or the like) utilizing that two substrates arranged to be away from each other, and face each other are in contact with each other by the pressing force, the touch panel (capacity type or the like) utilizing that a distance between the two substrates is narrowed by the pressing force, and the like belong. In comparison with the contact type touch panel, the capacity type touch panel may detect the touch without applying a pressure of the level that the two substrates are in contact with each other, and has a feature that the high touch detection sensitivity may be easily realized as a result.

Generally, the high touch detection sensitivity is desired in the touch panel, and various attempts have been made to improve the sensitivity. For example, in “Integrated Active Matrix Capacitive Sensors for Touch Panel LTPS-TFT LCDs”, E. Kanda et al., SID DIGEST, pp. 834-837, 2008, in the capacity type touch panel integrated with the display device, the touch panel in which further improvement of the touch detection sensitivity is attempted by providing a transistor for amplification in each touch sensor has been disclosed.

Generally, in an electronic device, reduction of the number of elements is desired from many viewpoints such as reduction of a power consumption, reduction of a manufacturing cost, and improvement of reliability. Also in the touch panel, these improvements may be expected by reducing the number of elements in the touch panel. Further, for example, in the case where the touch panel is mounted on the display device, it may be possible to minimize reductions of display luminance caused by the touch panel when an image is displayed on the display device through the touch panel. Further, in the case where the touch panel and the display device are integrated, it may be possible to increase an aperture ratio of the display device.

However, in the touch panel integrated with the display device which has been disclosed in “Integrated Active Matrix Capacitive Sensors for Touch Panel LTPS-TFT LCDs”, E. Kanda et al., SID DIGEST, pp. 834-837, 2008, in addition to the transistor for amplification, a control line and a control transistor for controlling the transistor for amplification are necessary in each touch sensor, and there is a risk that the aperture ratio of the display device is reduced.

In view of the foregoing, it is desirable to provide a display device with a touch sensor capable of realizing a high touch detection sensitivity without increasing a number of elements, a touch panel, a method of driving a touch panel, and an electronic device.

### SUMMARY

The present disclosure relates to a display device with a touch sensor in which a touch sensor detecting an external proximity object is incorporated, a touch panel, a method of driving a touch panel, and an electronic device.

According to an example embodiment of the present disclosure, there is provided an electronic device including: the display device with the touch sensor; and the touch panel of the present disclosure, and a television device, a digital camera, a notebook personal computer, a video camera, a mobile terminal device such as a mobile phone, or the like corresponds to the electronic device.

In the display device with the touch sensor, the touch panel, the method of driving the touch panel, and the electronic device of the present disclosure, first, the initialization is performed in such a manner that the voltage is set for the signal line and the voltage is set for the first electrode. At the time of this initialization, the first electrode and the second electrode are in the state in accordance with the stressing force of the external proximity object. In other words, in the case of the strong stressing force, the first electrode and the second electrode are in contact with each other. In the case of the weak stressing force, the distance between the first electrode and the second electrode is narrowed, and the capacitance between the first electrode and the second electrode is increased in comparison with the case of the state where the touch is not made. After this initialization, when the switch is ON, a charge transfer occurs between the signal line and the first electrode, and the touch voltage in accordance with the stressing force of the external proximity object is output to the signal line through the switch. At the time of this initialization, the initialization is performed on the signal line and the first electrode to increase the potential difference between the voltage of the signal line and the voltage of the first electrode, and therefore the touch voltage may be increased.

In one example embodiment, a display device includes a drive control section and a signal line operatively coupled to the drive control section. In this example embodiment, the signal line has a first voltage. In one example embodiment, a display section is operatively coupled to the drive control section, wherein the display section includes: (a) a touch detection element configured to output a touch voltage; and (b) an electrode having a second voltage. In one example embodiment, the drive control section is configured to, before the touch detection element outputs the touch voltage, increase a potential difference between: (i) the first voltage of the signal line; and (ii) the second voltage of the electrode.

In one example embodiment, the touch voltage is defined based on the potential difference.

In one example embodiment, the potential difference corresponds to touch detection sensitivity.

In one example embodiment, the display section includes a sensor column having a portion. In one example embodiment, the electrode is configured to cover the portion of the sensor column. In one example embodiment, the sensor column is formed on one of a first substrate and a second substrate. In one example embodiment, the second substrate is arranged to face the first substrate.

In one example embodiment, the touch voltage corresponds to a stressing force of an external proximity object.

In one example embodiment, the drive control section is configured to, for a first initialization, supply a first precharge voltage to the electrode. In one example embodiment, the supplied first precharge voltage is based on a first level of an inversion common signal. In one example embodiment, the first initialization is performed before the display section performs a display operation. In one example embodiment, the first initialization is performed in synchronization with the first level of the inversion common signal.

In one example embodiment, the drive control section is configured to, for a second initialization, supply a second precharge voltage to the signal line. In one example embodiment, the supplied second precharge voltage is based on a second level of the inversion common signal. In one example embodiment, the second initialization is performed before the display section performs a display operation. In one example embodiment, the second initialization is performed in synchronization with the second level of the inversion common signal.

In one example embodiment, the display device includes a liquid crystal element operatively coupled to a common signal line which supplies a common signal for a display operation. In one example embodiment, the display device includes a capacitor operatively connected to the liquid crystal element. In one example embodiment, the capacitor is supplied with the common signal.

In one example embodiment, the display device includes a sensor control line operatively connected to a capacitor. In this example embodiment, the common signal has a first voltage amplitude. In one example embodiment, the sensor control line is supplied with a sensor control line signal which has a second voltage amplitude. In this example embodiment, the second amplitude voltage is larger than the first voltage amplitude.

In one example embodiment, the drive control section is configured to activate a gate line signal to at least two gate lines. In one example embodiment, the at least two gate lines are activated at the same time and are operatively coupled to the drive control section.

In one example embodiment, the display device includes a dummy touch detection element located outside a touch detection region. In one example embodiment, the dummy touch detection element is configured to supply a reference voltage. In one example embodiment, the display device includes a dummy signal line operatively coupled to the drive control section.

In one example embodiment, a method of operating a display device includes: causing a drive control section to, before a touch detection element of a display section outputs a touch voltage, increase a potential difference between: (i) a first voltage of a signal line; and (ii) a second voltage of an electrode of the display section.

In one example embodiment, the touch voltage is defined based on the potential difference.

In one example embodiment, the potential difference corresponds to touch detection sensitivity.

In one example embodiment, the display section includes a sensor column having a portion. In one example embodiment, the electrode is configured to cover the portion of the sensor column. In one example embodiment, the sensor column is formed on one of a first substrate and a second substrate, the second substrate being arranged to face the first substrate.

In one example embodiment, the touch voltage corresponds to a stressing force of an external proximity object.

In one example embodiment, the method includes, for a first initialization, causing the drive control section to supply a first precharge voltage to the electrode. In one example embodiment, the supplied first precharge voltage is based on a first level of an inversion common signal. In one example embodiment, the first initialization is performed before the display section performs a display operation. In one example embodiment, the first initialization is performed in synchronization with the first level of the inversion common signal.

In one example embodiment, the method includes, for a second initialization, causing the drive control section to supply a second precharge voltage to the signal line, the supplied second precharge voltage being based on a second level of the inversion common signal. In one example embodiment, the second initialization is performed before the display section performs a display operation. In one example embodiment, the second initialization is performed in synchronization with the second level of the inversion common signal.

In one example embodiment, the method includes causing a common signal line to supply a common signal for a display operation, wherein a liquid crystal element is operatively coupled to the common signal line.

In one example embodiment, the method includes supplying a capacitor operatively connected to the liquid crystal element with the common signal.

In one example embodiment, a sensor control line is operatively connected to a capacitor, the common signal having a first voltage amplitude, the sensor control line being supplied with a sensor control line signal which has a second voltage amplitude, the second amplitude voltage being larger than the first voltage amplitude.

In one example embodiment, the method includes causing the drive control section to activate a gate line signal to at least two gate lines. In one example embodiment, the at least two gate lines are activated at the same time and are operatively coupled to the drive control section.

In one example embodiment, the method includes causing a dummy touch detection element to supply a reference voltage, the dummy touch detection element being: (a) located outside a touch detection region; and (b) operatively coupled to the drive control section.

In one example embodiment, a touch panel includes a drive control section operatively coupled to a signal line and an electrode. In one example embodiment, the signal line has a first voltage and the electrode has a second voltage. In one example embodiment, the touch panel includes a touch detection element configured to output a touch voltage. In one example embodiment, the drive control section is configured to, before the touch detection element outputs the touch voltage, increase a potential difference between: (i) the first voltage of the signal line; and (ii) the second voltage of the electrode.

According to the display device with the touch sensor, the touch panel, the method of driving the touch panel, and the electronic device of the present disclosure, because the initialization is performed on the signal line and the first electrode to increase the potential difference between the voltage of the signal line and the voltage of the first electrode before the capacity type touch detection element outputs the touch voltage, it may be possible to realize high sensitivity to the touch without increasing the number of elements.

Additional features and advantages are described herein, and will be apparent from the following Detailed Description and the figures.

### BRIEF DESCRIPTION OF THE DRAWINGS

FIG. 1 is a block diagram' illustrating a structural example of a display device with a touch sensor according to a first embodiment of the present disclosure.

FIG. 2 is a circuit view illustrating a structural example of a main part of the display device with the touch sensor illustrated in FIG. 1.

FIG. 3 is a cross-sectional view illustrating a structural example of a main part of a display section with a built-in touch sensor illustrated in FIG. 1.

FIG. 4 is a circuit view illustrating a structural example of a pixel and a peripheral part thereof illustrated in FIG. 2.

FIG. 5 is a timing waveform diagram illustrating an operational example of the display device with the touch sensor illustrated in FIG. 1.

FIG. 6 is a timing waveform diagram illustrating another operational example of the display device with the touch sensor illustrated in FIG. 1.

FIG. 7 is a circuit view illustrating a structural example of a main part of the display device with the touch sensor according to a modification of the first embodiment of the present disclosure.

FIG. 8 is a timing waveform diagram illustrating an operational example of the display device with the touch sensor illustrated in FIG. 7.

FIG. 9 is a timing waveform diagram illustrating an operational example of the display device with the touch sensor according to a second embodiment of the present disclosure.

FIG. 10 is a plot diagram illustrating a characteristic example of the display device with the touch sensor illustrated in FIG. 9.

FIG. 11 is a block diagram illustrating a structural example of the display device with the touch sensor according to a third embodiment of the present disclosure.

FIG. 12 is a perspective view illustrating an appearance structure of a first application example in the display device with the touch sensor to which the embodiments are applied.

FIGS. 13A and 13B are perspective views illustrating appearance structures of a second application example.

FIG. 14 is a perspective view illustrating an appearance structure of a third application example.

FIG. 15 is a perspective view illustrating appearance structures of a fourth application example.

FIGS. 16A to 16G are front views, side views, top face views, and bottom face views illustrating appearance structures of a fifth application example.

FIG. 17 is a circuit view illustrating a modification of the display device with the touch sensor.

FIG. 18 is a circuit view illustrating another modification of the display device with the touch sensor.

### DETAILED DESCRIPTION OF THE PREFERRED EMBODIMENTS

Example embodiments of the present disclosure will be hereinafter described in detail with reference to the drawings. The description will be made in the following order:

1. First example embodiment

2. Second example embodiment

3. Third example embodiment

4. Application examples

### 1. First Embodiment

### Structural Example

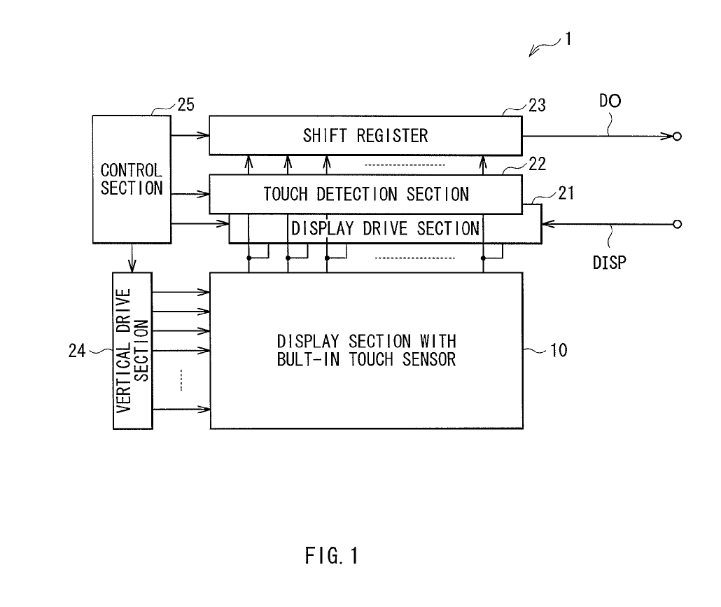

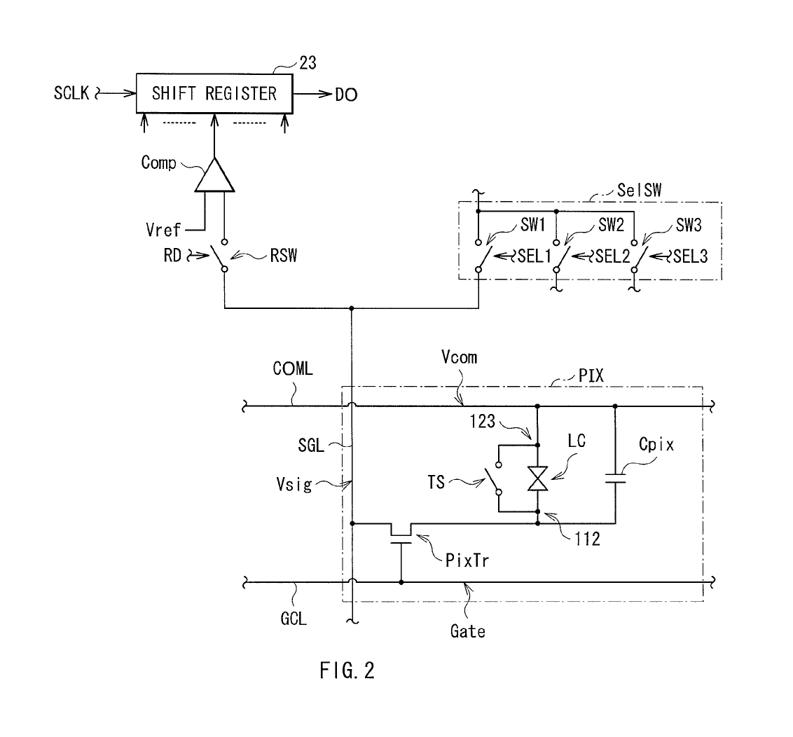

FIG. 1 illustrates a structural example of a display device with a touch sensor according to a first embodiment of the present disclosure. FIG. 2 illustrates a structural example of a main part of the display device with the touch sensor. Because a method of driving a touch panel according to the embodiments of the present disclosure is realized by this embodiment, its description will be given in this embodiment in addition. A display device 1 with a touch sensor is a so-called in-cell type display device in which a display panel and a touch panel are integrated. The display device 1 with the touch sensor uses a liquid crystal element as a display element, and is constituted by using a contact type touch sensor and a capacity type touch sensor as a touch sensor element. As illustrated in FIG. 1, the display device 1 with the touch sensor includes a display section with a built-in touch sensor 10, a display drive section 21, a touch detection section 22, a shift register 23, a vertical drive section 24, and a control section 25.

The display section 10 with the built-in touch sensor performs a display based on a supplied display pixel signal, and outputs a touch voltage Vtouch corresponding to a stressing force of an external proximity object. In the display section 10 with the built-in touch sensor, pixels PIX are arranged in a matrix. As illustrated in FIG. 2, the pixel PIX includes a liquid crystal element LC, a touch sensor TS, a pixel transistor PixTr, and a pixel capacity Cpix.

The liquid crystal element LC is a display element performing the display based on the supplied display pixel signal. The touch sensor Ts is a touch sensor element outputting the touch voltage Vtouch corresponding to the stressing force of the external proximity object. The liquid crystal element LC and the touch sensor element TS are connected in parallel.

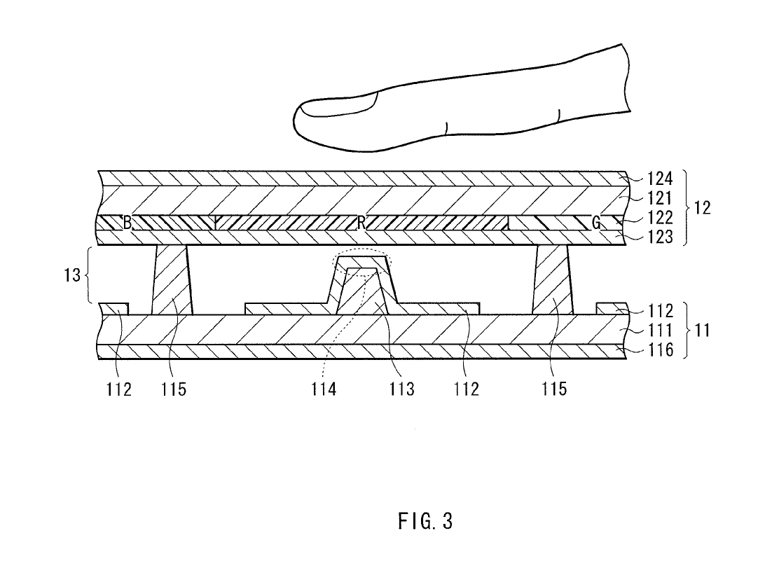

FIG. 3 illustrates an example of the cross-sectional structure of a main part of the display section 10 with the built-in touch sensor. The pixel PIX includes an array substrate 11, a color filter substrate 12 arranged to face the array substrate 11, and a liquid crystal layer 13 inserted between the array substrate 11 and the color filter substrate 12.

The array substrate 11 includes a TFT substrate 111 serving as a circuit substrate, and a plurality of pixel electrodes 112 formed in the matrix on a face of the TFT substrate 111, which is in contract with the liquid crystal layer 13. A sensor column 113 is formed in a part on the TFT substrate 111, and the pixel electrode 112 is formed to cover the top part of the sensor column 113. Therefore, a distance between the pixel electrode 112 (a sensor electrode 114) of the top part of the sensor column 113, and a common electrode 123 (will be described later) formed on the color filter substrate 12 is narrowed in comparison with the place without the sensor column 113. Further, a polarizing plate 116 is formed on a face of the TFT substrate 111, which is opposite from the liquid crystal layer 13.

The color filter substrate 12 includes a facing substrate 121, a color filter 122 formed on a face of the facing substrate 121, which faces the array substrate 11, and the common electrode 123 formed on the color filter 122. The color filter 122 is, for example, constituted by periodically aligning color filter layers of three colors of red (R), green (G), and blue (B). Further, a polarizing plate 124 is formed on a face of the facing substrate 121, which is opposite from the liquid crystal layer 13.

The liquid crystal layer 13 modulates a polarization direction of passing light in accordance with the state of an electric field. As a liquid crystal, for example, the liquid crystal of various modes such as TN (twisted nematic), VA (vertical alignment), and ECB (electrically controlled birefringence) is used.

A spacer 115 is formed between the array substrate 11 and the color filter substrate 12. The spacer 115 is provided so that the array substrate 11 and the color filter substrate 12 maintain a predetermined gap in between.

The pixel electrode 112, the common electrode 123, and the liquid crystal layer 13 constitute the liquid crystal element LC. Specifically, the liquid crystal element LC performs the display based on a potential difference of the display pixel signal applied to the pixel electrode 112, and the common signal Vcom applied to the common electrode 123. For example, correspondingly to the color filter 122, the liquid crystal element LC performs the display by red (R), green (G), and blue (B), respectively. The liquid crystal element LC performs the display by a line inversion drive in this example. In other words, the common signal Vcom is inverted in each horizontal line period.

The pixel electrode 112 (the sensor electrode 114) and the common electrode 123 constitute the touch sensor TS. In the touch sensor TS, the color filter substrate 12 is deflected by the stressing force of the external adjacent object, and the distance between the sensor electrode 114 and the common electrode 123 is narrowed. In the case where the stressing force is weak, because the distance between the both electrodes is narrowed, the capacitance between the sensor electrode 114 and the common electrode 123 is changed. In the case where the stressing force is strong, the sensor electrode 114 and the common electrode 123 are in contact with each other. The touch sensor TS outputs the touch voltage Vtouch from the pixel electrode 112 in accordance with the distance between the sensor electrode 114 and the common electrode 123. Hereinafter, as the voltage of the pixel electrode 112, a pixel voltage Vpix is appropriately used.

In this example, although the sensor column 113 is formed in the array substrate 11, in substitution for this, the sensor column 113 may be formed in the color filter substrate 12, or may be formed in both the array substrate 11 and the color filter substrate 12. In the case where the sensor column 113 is formed in the color filter substrate 12, the common electrode 123 is formed to cover the sensor column 113.

The pixel transistor PixTr is, for example, formed as a TFT (thin film transistor) on the array substrate 11. As illustrated in FIG. 2, in the pixel transistor PixTr, one of a source and a drain is connected to a signal line SGL (will be described later), and the other is connected to the liquid crystal element LC and the touch sensor TS. In the pixel transistor PixTr, a gate is connected to a gate line GCL (will be described later), and is controlled to turn on/off based on the voltage of the gate line GCL. As will be described later, the pixel transistor PixTr transmits the display pixel signal, which is supplied from the signal line SGL, to the liquid crystal element LC, and transmits the touch voltage Vtouch, which is output from the touch sensor TS, to the signal line SGL.

A pixel capacity Cpix is formed on the array substrate 11. In the pixel capacity Cpix, one end is connected to the pixel electrode 112 of the liquid crystal element LC, and the other end is connected to a common signal line COML (will be described later) disposed on the array substrate 11. The pixel capacity Cpix is a capacity to hold the voltage of both ends of the liquid crystal element LC, and the pixel capacity Cpix and the liquid crystal element LC are connected in parallel. The pixel capacity Cpix is constituted of a so-called retention capacity and a parasitic capacity.

The signal line SGL is formed on the array substrate 11, and is connected to the plurality of pixels PIX belonging to the same column in the pixels PIX aligned in the matrix in the display section 10 with the built-in touch sensor. Further, the signal line SGL is connected to the display drive section 21 and the touch detection section 22 at the outside of the display section 10 with the built-in touch sensor. With this structure, the signal line SGL transmits the display pixel signal, which is supplied from the display drive section 21, to the liquid crystal element LC of each pixel PIX, and transmits the touch voltage Vtouch, which is supplied from the touch sensor TS of each pixel PIX, to the touch detection section 22. Hereinafter, as the voltage of the signal line SGL, a signal line voltage Vsig which is a collective term for the display pixel signal and the touch voltage Vtouch is appropriately used.

The gate line GCL is formed on the array substrate 11, and is connected to the plurality of pixels PIX belonging to the same row in the pixels PIX aligned in the matrix in the display section 10 with the built-in touch sensor. The gate line GCL is connected to the vertical drive section 24 at the outside of the display section 10 with the built-in touch sensor.

The common signal line COML is formed on the array substrate 11, and is a wiring transmitting the common signal Vcom. The common signal line COML is connected to the common electrode 123 on the color filter substrate 12 in the display section 10 with the built-in touch sensor. Although not illustrated in the figure, the common signal line COML is connected to the control section 25 at the outside of the display section 10 with the built-in touch sensor, and the common signal Vcom is supplied from the control section 25 to the common signal line COML.

The display drive section 21 is a circuit supplying the display pixel signal to the liquid crystal element LC of the display section 10 with the built-in touch sensor. Specifically, the display drive section 21 has a function to generate the display pixel signal based on a video display signal DISP supplied from the outside, and to supply the display pixel signal to the liquid crystal element LC through the signal line SGL.

Further, the display drive section 21 has a function to perform a precharge operation in which a predetermined voltage (precharge voltage) is applied to the signal line SGL. Specifically, as will be described later, before supplying the display pixel signal to the liquid crystal element LC through the signal line SGL, the display drive section 21 applies the predetermined voltage based on the common signal Vcom to the signal line SGL, and therefore initializes the signal line SGL. Thus, the display pixel signal is easily applied to the signal line SGL, and the display operation is easily performed. Before the touch sensor TS outputs the touch voltage Vtouch, the display drive section 21 applies different predetermined voltages based on the common signal Vcom to the pixel electrode 112 and the signal line SGL, respectively, and therefore initializes the touch sensor TS and the signal line SGL, respectively. Thus, the touch sensor TS may output the touch voltage Vtouch which is not dependent on the display pixel signal.

As illustrated in FIG. 2, the display drive section 21 and the signal line SGL are connected through a selector switch SelSW. The selector switch SelSW is constituted of switches SW1 to SW3 controlled to turn on/off by selector signals SEL1 to SEL2, respectively. For example, the switch SW1 controlled to turn on/off by the selector signal SEL1 is connected to the signal line SGL of the pixel PIX which displays blue (B), the switch SW2 controlled to turn on/off by the selector signal SEL2 is connected to the signal line SGL of the pixel PIX which displays green (G), and the switch SW3 controlled to turn on/off by the selector signal SEL3 is connected to the signal line SGL of the pixel PIX which displays red (R). The selector switch SelSW is controlled to be ON in a period when the display pixel signal is applied to the signal line SGL, and in a period when the precharge operation is performed (a precharge period), and is controlled to be OFF in a period when the signal line SGL is used for a touch detection operation (a touch detection period).

The touch detection section 22 is a circuit detecting the touch based on the touch voltage Vtouch supplied from the touch sensor TS. Specifically, as will be described later, the touch detection section 22 compares the touch voltage Vtouch supplied to the touch detection section 22 through the signal line SGL from the touch sensors TS (one horizontal line) selected by the vertical drive section 24, and a predetermined reference voltage Vref by using a comparator Comp, and therefore functions to determine presence/absence of the touch in the touch sensor TS. The touch detection section 22 and the signal line SGL are connected through a read switch RSW. The read switch RSW is controlled to turn on/off by a read signal RD. The read switch RSW is controlled to be ON in the period when the signal line SGL is used for the touch detection operation (the touch detection period).

A shift resistor 23 is a circuit performing a parallel-serial conversion on a touch determination result supplied from the touch detection section 22. Specifically, the shift register 23 holds the touch determination result of the one horizontal line supplied from the touch detection section 22, performs the parallel-serial conversion on that touch determination result based on a serial clock signal SCLK supplied from the control section 25, and transfers the touch determination result as a touch detection signal DO to the outside. In other words, the shift resistor 23 may highly reduce the number of signal wirings for transmitting the touch determination result to the outside.

The vertical drive section 24 has a function to select the pixels PIX to be a target of the touch detection operation and the display operation. Specifically, the vertical drive section 24 applies the signal Gate to the gate control line GCL, and selects one line (one horizontal line) in the pixels PIX formed in the matrix in the display section 10 with the built-in touch sensor, as the target of the display operation and the touch detection operation. In the display operation, the display pixel signal is supplied from the display drive section 21 to the liquid crystal display elements LC of the selected pixels PIX, and therefore the display of that one horizontal line is performed. In the touch detection operation, after the touch sensors TS of the selected pixels PIX are initialized, the touch voltage Vtouch output from those touch sensors TS is detected by the touch detection section 22, and therefore the touch detection of that one horizontal line is performed. In this manner, the vertical drive section 24 time-divisionally sequentially scans each of the horizontal lines, and controls the display operation and the touch detection operation to be performed over the entire display section 10 with the built-in touch sensor.

The control section 25 is a circuit controlling the display drive section 21, the touch detection section 22, the shift resister 23, and the vertical drive section 24 to operate in synchronization with each other. Specifically, the control section 25 supplies the selector signals SEL1 to SEL3, and the common signal Vcom to the display drive section 21, supplies the read signal RD to the touch detection section 22, supplies the serial clock signal SCLK to the shift resister 23, and supplies a synchronization signal to the vertical drive section 24. Although not illustrated in the figure, the control section 25 supplies the common signal Vcom to the display section 10 with the built-in touch sensor.

Here, the array substrate 11 corresponds to a specific example of “first substrate” in the present disclosure, the color filter substrate 12 corresponds to a specific example of “second substrate” in the present disclosure, the pixel electrode 112 (the sensor electrode 114) corresponds to a specific example of “first electrode” in the present disclosure, and the common electrode 123 corresponds to a specific example of “second electrode” in the present disclosure. The pixel transistor PixTr corresponds to a specific example of “switch” in the present disclosure. The signal line SGL corresponds to a specific example of “signal line” in the present disclosure. The touch detection section 22 corresponds to a specific example of “signal detection section” in the present disclosure. The display drive section 21, the vertical drive section 24, and the control section 25 correspond to a specific example of “drive control section” in the present disclosure. The liquid crystal element LC corresponds to a specific example of “display element” in the present disclosure, and the touch sensor TS corresponds to a specific example of “touch detection element” in the present disclosure. The sensor column 113 corresponds to a specific example of “projection” in the present disclosure.

The common signal Vcom corresponds to a specific example of “common signal” in the present disclosure. The touch voltage Vtouch corresponds to a specific example of “touch voltage” in the present disclosure. The one horizontal line period corresponds to a specific example of “predetermined period” in the present disclosure. The pixel capacity Cpix corresponds to a specific example of “retention capacity” in the present disclosure.

(Operations and Actions)

Next, operations and actions of the display device 1 with the touch sensor of this embodiment will be described.

(Outline of Overall Operations)

The display drive section 21 generates the display pixel signal based on the video display signal DISP, generates the precharge voltage, and supplies the display pixel signal and the precharge voltage to the display section 10 with the built-in touch sensor through the signal line SGL. The vertical drive section 24 supplies the gate line signal Gate to the display section 10 with the built-in touch sensor through the gate ling GCL. The display section 10 with the built-in touch sensor line-sequentially scans each of the horizontal lines based on the gate line signal Gate of the gate line GCL, outputs the touch voltage Vtouch to the signal line SGL after each of the touch sensor TS and the signal line SGL is initialized, and performs the display operation when the display pixel signal is supplied to the display section 10 with the built-in touch sensor through the signal line SGL. The touch detection section 22 detects (determines) the touch based on the touch voltage Vtouch supplied to the touch detection section 22 through the signal line SGL. The shift resister 23 performs the parallel-serial conversion on the touch determination result of the one horizontal line supplied from the touch detection section 22, and transmits the touch determination result as the touch detection signal DO to the outside. Meanwhile, the control section 25 controls the display drive section 21, the touch detection section 22, the shift resister 23, and the vertical drive section 24 to operate in synchronization with each other.

(Detailed Operations)

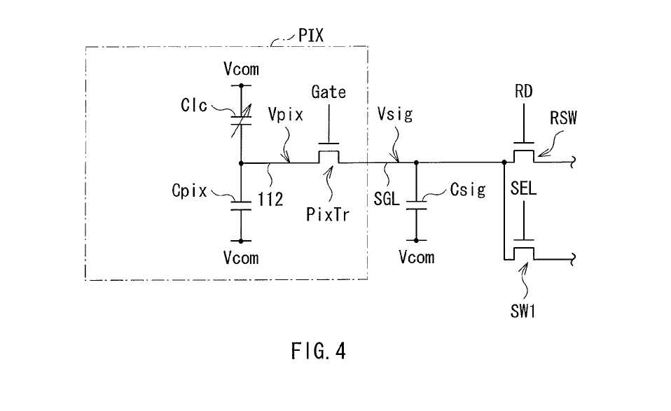

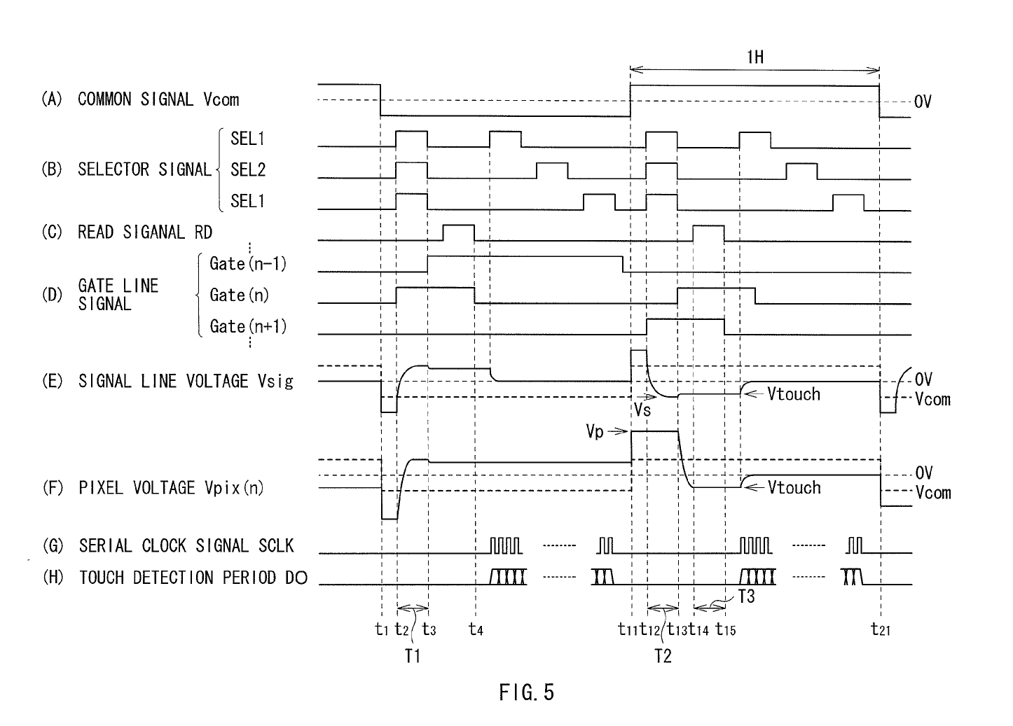

Next, with reference to FIGS. 4 and 5, detailed operations of the display device 1 with the touch sensor will be described.

FIG. 4 illustrates an example of the circuit structure of the pixel PIX and the periphery thereof. Here, the touch state in FIG. 4 is regarded as the state (weak touch state) where the distance between the pixel electrode 112 (the sensor electrode 114) and the common electrode 123 is slightly narrowed by the weak stressing force onto the display section 10 with the built-in touch sensor.

The pixel PIX includes a liquid crystal capacity Clc, a pixel capacity Cpix, and the pixel transistor PixTr. The liquid crystal capacity Clc corresponds to the capacitance between the pixel electrode 112 and the common electrode 123 through the liquid crystal layer 13 in FIG. 3, and corresponds to a parallel capacity of the capacity of the touch sensor TS and the capacity of the liquid crystal element LC in FIG. 2. In other words, in the weak touch state, because it is considered that the touch sensor TS functions as a variable capacity in which the capacitance is varied by the stressing force, the liquid crystal capacity Clc is also the variable capacity. In FIG. 4, one end of the liquid crystal capacity Clc is connected to one end of the pixel transistor PixTr, and the common signal Vcom is supplied to the other end of the liquid crystal capacity Clc. In the same manner as FIG. 2, one end of the pixel capacity Cpix is connected to the one end of the pixel transistor PixTr, and the common signal Vcom is supplied to the other end of the pixel capacity Cpix. The pixel electrode 112 is connected to the one end of the pixel transistor PixTr, and the voltage of the pixel electrode 112 corresponds to the pixel voltage Vpix. The other end of the pixel transistor PixTr is connected to the read switch RSW, the selector switch SelSW (the switch SW1 in this example), and a signal line capacity Csig through the signal line SGL. The signal line capacity Csig is the parasitic capacity between the signal line SGL and the common signal line COML. In other words, in the signal line capacity Csig, one end is connected to the signal line SGL, and the common signal Vcom is supplied to the other end.

FIG. 5 illustrates the timing waveform diagrams of the display operation and the touch detection operation in the display device 1 with the touch sensor, and illustrates the weak touch state. In FIG. 5, Part A illustrates the waveform of the common signal Vcom, Part B illustrates the waveforms of the selector signals SEL1 to SEL3, Part C illustrates the waveform of the read signal RD, Part D illustrates the waveform of the signal Gate of the gate line GCL, Part E illustrates the waveform of the signal line voltage Vsig of the signal line SGL, Part F illustrates the waveform of the pixel voltage Vpix, Part G illustrates the waveform of the serial clock signal SCLK, and Part H illustrates the waveform of the touch detection signal DO. FIG. 5 focuses on the pixel PIX which is located on an n^{th} line of the pixels PIX aligned in the matrix, and the pixel voltage Vpix of Part F of FIG. 5 indicates a pixel voltage Vpix(n) of the pixel electrode 112 in that pixel PIX. When the selector signals SEL1 to SEL3 (Part B of FIG. 5), the read signal RD (Part C of FIG. 5), and the gate line signal Gate (Part D of FIG. 5), as being the control signals of the switches and the transistor, are on the high level, the corresponding switches and the corresponding transistor are set to be ON. In other words, when the selector signals SELL to SEL3 (Part B of FIG. 5) are on the high level, the switches SW1 to SW3 of the selector switch SelSW are ON. When the read signal RD (Part C of FIG. 5) is on the high level, the read switch RSW is ON. When the gate line signal Gate (Part D of FIG. 5) is on the high level, the pixel transistor PixTr is ON.

Further, the signal line voltage Vsig (Part E of FIG. 5) is a voltage of the signal line SGL connected to the switch SW1 to which the selector signal SEL1 is supplied.

As illustrated in FIG. 5, in the display device 1 with the touch sensor, in the certain one horizontal line period (from a timing t1 to a timing t11), the pixel electrode 112 of the pixel PIX located on the n^{th} line is precharged (a pixel electrode precharge period T1). In the subsequent one horizontal line period (from a timing t11 to a timing t21), the signal line SGL is precharged (a signal line precharge period T2), the pixel PIX on the n^{th} line outputs the touch voltage Vtouch, and the touch detection section 22 performs the touch determination (a touch detection period T3) based on the touch voltage Vtouch. Thereafter, the shift register transfers the touch determination result to the outside, and the pixel PIX on the n^{th} line performs the display operation.

Here, the operation in the pixel electrode precharge period T1 corresponds to a specific example of “first initialization” in the present disclosure, and the operation in the signal line precharge period T2 corresponds to a specific example of “second initialization” in the present disclosure.

First, the operation in the timing t1 to the timing t11 will be described.

First, in the timing t1, the control section 25 inverts the common signal Vcom. Specifically, when all of the selector signals SEL1 to SEL3, the read signal RD, and the gate line signal Gate are on the low level (Part B to Part D of FIG. 5), the control section 25 changes the common signal Vcom from the high level to the low level (Part A of FIG. 5). At this time, the signal line SGL is shut off from all the pixels PIX, and both of the signal line SGL and the pixel electrode 112 are in the floating state. Thus, the common signal Vcom is transmitted to the signal line SGL through the signal line capacity Csig, and therefore the signal line voltage Vsig is changed to the low level side (Part E of FIG. 5), and, at the same time, the common signal Vcom is transmitted to the pixel electrode 112 through the liquid crystal capacity Clc and the pixel capacity Cpix, and therefore the pixel voltage Vpix(n) is also changed to the low level side (Part F of FIG. 5).

Next, in the period from the timing t2 to the timing t3 (the pixel electrode precharge period T1), the display drive section 21 precharges the pixel electrode 112 on the n^{th} line. Specifically, first, in the timing t2, the control section 25 changes all of the selector signals SEL1 to SEL3 from the low level to the high level (Part B of FIG. 5). Therefore, the display drive section 21 performs the precharge operation, applies the voltage level of an inversion common signal xVcom (not illustrated in the figure), in which the voltage of the common signal Vcom is inverted, as the precharge voltage to the signal line SGL, and sets the signal line voltage Vsig as the precharge voltage (here, the high level voltage of the common signal Vcom) (Part E of FIG. 5). At the same time, the vertical drive section 24 changes the gate line signal Gate(n) on the n^{th} line from the low level to the high level (Part D of FIG. 5). Therefore, the pixel transistor PixTr of the pixel PIX on the n^{th} line is ON, the precharge voltage is supplied to the pixel electrode 112 on the n^{th} line, and the pixel voltage Vpix(n) is set as the precharge voltage (Part F of FIG. 5).

Next, in the timing t3, the control section 25 changes all of the selector signals SEL1 to SEL3 from the high level to the low level (Part B of FIG. 5). Therefore, the signal line SGL and the pixel electrode 112 on the n^{th} line are in the floating state while being connected to each other. At the same time, the vertical drive section 24 changes the gate line signal Gate(n−1) on the n−1^{th} line from the low level to the high level (Part D of FIG. 5), and sets the pixel transistor PixTr of the pixel PIX on the n−1^{th} line to be ON. Therefore, in the timing t2 to the timing t3, the charge transfer occurs between the signal line SGL and the pixel electrode 112 on the n^{th} line, and between the signal line SGL and the pixel electrode 112 on the n−1^{th} line. As a result, although the signal line voltage Vsig and the pixel voltage Vpix(n) are slightly reduced, the signal line voltage Vsig and the pixel voltage Vpix(n) still maintain the voltage close to the voltage level of the inversion common signal xVcom (Part E and Part F of FIG. 5).

Next, in the timing t4, the vertical drive section 24 changes the gate line signal Gate(n) on the n^{th} line from the high level to the low level (Part D of FIG. 5). Therefore, the pixel transistor PixTr of the pixel PIX on the n^{th} line is OFF, and the pixel electrode 112 on the n^{th} line is in the floating state. In other words, the pixel voltage Vpix(n) maintains the voltage set in the pixel electrode precharge period T1 (Part F of FIG. 5).

As described above, in the pixel electrode precharge period T1, the pixel electrode 112 on the n^{th} line is set to have the voltage level of the inversion common signal xVcom and initialized, and then the pixel voltage Vpix(n) of that pixel electrode 112 maintains the voltage close to the set voltage. In the pixel electrode precharge period T1, both of the signal line precharge for the display, and the pixel electrode precharge for the touch detection are performed.

Thereafter, in the timing t4 to the timing t11, the pixel PIX on the n−1^{th} line performs the display operation based on the display pixel signal supplied by the display drive section 21. Specifically, first, the control section 25 sequentially time-divisionally supplies the waveforms of predetermined pulse widths as the selector signals SEL1 to SEL3 to the selector switch SelSW, and sequentially sets the switches SW1 to SW3 to be ON correspondingly to the selector signals SEL1 to SEL3. Accordingly, the display drive section 21 sequentially supplies the display pixel signal to the corresponding signal line SGL, and changes the signal line voltage Vsig (Part E of FIG. 5). In this example, because the focused signal line SGL is connected to the switch SW1 to which the selector signal SEL1 is supplied, the signal line voltage Vsig is changed when the selector signal SEL1 is on the high level (Part E of FIG. 5). The signal line voltage Vsig is supplied to the pixel electrode 112 of the pixel PIX on the n−1^{th} line in which the pixel transistor PixTr is ON, and the pixel PIX on the n−1^{th} line performs the display operation in response to the signal line voltage Vsig.

After the display operation is completed, the vertical drive section 24 changes the gate line signal Gate(n−1) on the n−1^{th} line from the high level to the low level (Part D of FIG. 5). Therefore, the signal line SGL is shut off from all the pixels PIX, and both of the signal line SGL and the pixel electrode 112 are in the floating state.

Next, the operation in the period from the timing t11 to the timing t21 will be described.

First, in the timing t11, the control section 25 inverts the common signal Vcom. Specifically, when all of the selector signals SEL1 to SEL3, the read signal RD, and the gate line signal Gate are on the low level (Part B to Part D of FIG. 5), the control section 25 changes the common signal Vcom from the low level to the high level (Part A of FIG. 5). At this time, because both of the signal line SGL and the pixel electrode 112 are in the floating state, the common signal Vcom is transmitted to the signal line SGL through the signal line capacity Csig, and therefore the signal line voltage Vsig is changed to the high level side (part E of FIG. 5), and, at the same time, the common signal Vcom is transmitted to the pixel electrode 112 through the liquid crystal capacity Clc and the pixel capacity Cpix, and therefore the pixel voltage Vpix(n) is also changed to the high level side and becomes a voltage Vp (Part F of FIG. 5).

Next, in the period from the timing t12 to the timing t13 (the signal line precharge period T2), the display drive section 21 precharges the signal line SGL. Specifically, first, in the timing t12, the control section 25 changes all of the selector signals SEL1 to SEL3 from the low level to the high level (Part B of FIG. 5). Therefore, the display drive section 21 performs the precharge operation, applies the voltage level of an inversion common signal xVcom as the precharge voltage to the signal line SGL, and the signal line voltage Vsig is set as the precharge voltage (here, the low level voltage of the common signal Vcom) and becomes a voltage Vs (Part E of FIG. 5).

Next, in the timing t13, the control section 25 changes all of the selector signals SEL1 to SEL3 from the high level to the low level (Part B of FIG. 5). Therefore, the signal line SGL is in the floating state. At the same time, the vertical drive section 24 changes the gate line signal Gate(n) on the n^{th} line from the low level to the high level (Part D of FIG. 5), and sets the pixel transistor PixTr of the pixel PIX on the n^{th} line to be ON. Therefore, in the timing t12 to the timing t13, the charge transfer occurs between the signal line SGL and the pixel electrode 112 on the n^{th} line.

As described above, the pixel voltage Vpix(n) of the pixel electrode 112 on the n^{th} line is set to be the voltage close to the high voltage level of the common signal Vcom in the pixel electrode precharge period T1 (from the timing t2 to the timing t4), and then the common signal Vcom is transmitted to the pixel electrode 112 on the n^{th} line through the liquid crystal capacity Clc and the pixel capacity Cpix in the timing t11. Therefore, the pixel voltage Vpix(n) is changed to the high level side and becomes the voltage Vp. In other words, before the timing t13, the pixel voltage Vpix(n) of the pixel electrode 112 on the n^{th} line is set to be the voltage (the voltage Vp) higher than the high level voltage of the common signal Vcom.

Meanwhile, as described above, the signal line voltage Vsig of the signal line SGL is set to be the low level voltage of the common signal Vcom in the signal line precharge period T2 (from the timing t12 to the timing t13), and becomes the voltage Vs. In other words, before the timing t13, the signal line voltage Vsig of the signal line SGL is the low level voltage (the voltage Vs) of the common signal Vcom.

Therefore, before the timing t13, that is, before the charge transfer occurs between the signal line SGL and the pixel electrode 112 on the n^{th} line, a potential difference Vp−Vs as the potential difference between the pixel voltage Vpix(n) (the voltage Vp) of the pixel electrode 112 on the n^{th} line and the signal line voltage Vsig (the voltage Vs) of the signal line SGL is increased to have the voltage amplitude approximately twice the voltage amplitude of the common signal Vcom, as illustrated in Part E and Part F of FIG. 5. This highly contributes to improve the touch detection sensitivity, as will be described later.

In the timing t13, when the signal line SGL and the pixel electrode 112 on the n^{th} line are connected to each other, and the charge transfer occurs therebetween, the signal line voltage Vsig and the pixel voltage Vpix(n) are changed to the touch voltage Vtouch expressed by a ratio of the signal line capacity Csig and the capacity in the pixel (the liquid crystal capacity Clc and the pixel capacity Cpix) (Part E and Part F of FIG. 5). This touch voltage Vtouch is represented by the following equation.

$$\begin{matrix}Equation 1 & \\ {V}_{touch} = \frac{( {C}_{pix} + {C}_{ lc} ) \times {V}_{p} + {C}_{gig} \times {V}_{s}}{{C}_{sig} + {C}_{pix} + {C}_{lc }} & ( 1 )\end{matrix}$$

As obviously seen from the equation 1, the touch voltage Vtouch is changed according to the liquid crystal capacity Clc. In other words, the touch voltage Vtouch has the value corresponding to the change of the liquid crystal capacity Clc caused by the stressing force (touch) of the external proximity object. Therefore, as will be described below, the touch is detected based on this touch voltage Vtouch in the display device 1 with the touch sensor.

Next, in the period from the timing t14 to the timing t15 (the touch detection period T3), the touch detection is performed. Specifically, in the timing t14, the control section 25 changes the read signal RD from the low level to the high level (Part C of FIG. 5). Therefore, the read switch RSW is ON, and the touch voltage Vtouch is supplied to the comparator Comp. The comparator Comp determines the presence/absence of the touch by comparing the touch voltage Vtouch and the predetermined reference voltage Vref, and outputs the determination result. The shift resister 23 acquires the determination result. Therefore, the touch determination result of the one horizontal line is held in the shift resister 23. In the timing t15, the control section 25 changes the read signal RD from the high level to the low level (Part C of FIG. 5), completes supplying the touch voltage Vtouch to the comparator Comp, and the comparator Comp (the touch detection section 22) completes the touch detection (determination).

As described above, in the period from the timing t12 to the timing t15, the signal line precharge (the signal line precharge period T2) for the touch detection, and the touch detection (the touch detection period T3) are performed. In other words, in the period from the timing t12 to the timing t15, both of the signal line precharge for the display and the touch detection, and the touch detection are performed.

Thereafter, in the period from the timing t15 to the timing t21, the pixel PIX on the n^{th} line performs the display operation in the same manner as the display operation of the pixel PIX on the n−1^{th} line in the period from the timing t4 to the timing t11. Specifically, first, the control section 25 sequentially time-divisionally supplies the waveforms of the predetermined pulse widths as the selector signals SEL1 to SEL3 to the selector switch SelSW, and sequentially sets the switches SW1 to SW3 to be ON correspondingly to the selector signals SEL1 to SEL3, respectively. Accordingly, the display drive section 21 sequentially supplies the display pixel signal to the corresponding signal line SGL, and changes the signal line voltage Vsig (Part E of FIG. 5). The signal line voltage Vsig is supplied to the pixel electrode 112 of the pixel PD(on the n^{th} line in which the pixel transistor PixTr is ON, and the pixel PIX on the n^{th} line performs the display operation in response to the signal line voltage Vsig.

After the display operation is completed, the vertical drive section 24 changes the gate line signal Gate(n) on the n^{th} line from the high level to the low level (Part D of FIG. 5). Therefore, the signal line SGL is shut off from all the pixels PIX, and both of the signal line SGL and the pixel electrode 112 are in the floating state.

In parallel to this display operation, the shift resister 23 transmits the touch determination result, which is supplied from the touch detection section 22, to the outside. Specifically, first, the control section 25 supplies the serial clock signal SCLK to the shift resister 23 (Part G of FIG. 5). Based on the serial clock signal SCLK, the shift resister 23 transmits the held touch determination result of the one horizontal line as the touch detection signal DO to the outside (Part H of FIG. 5).

After the display operation is completed, the vertical drive section 24 changes the gate line signal Gate(n−1) on the n−1^{th} line from the high level to the low level (Part D of FIG. 5). Therefore, the signal line SGL is shut off from all the pixels PIX, and both of the signal line SGL and the pixel electrode 112 are in the floating state.

By repeating the above-described operation in the timing t1 to the timing t21, the display device 1 with the touch sensor sequentially performs the operation for each horizontal line of all the lines in the display section 10 with the built-in touch sensor, and performs the display operation and the touch detection operation. Specifically, the period from the timing t12 to the timing t14 corresponds to the pixel electrode precharge period T1 to the pixel electrode 112 on the n+1^{th} line, and after the signal line precharge period in the next one horizontal line period which starts from the timing t21 is passed, the touch detection is performed on the one horizontal line on the n+1^{th} line.

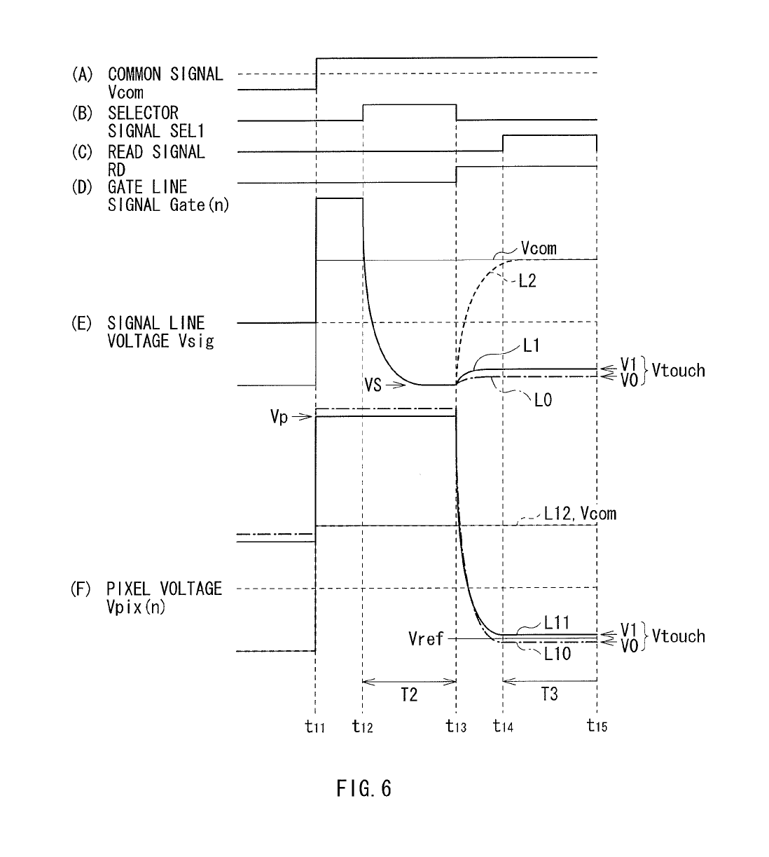

Next, with reference to FIG. 6, the relationship between the touch state and the touch voltage Vtouch will be descried.

FIG. 6 illustrates the timing waveform diagrams of the touch detection operation of the display device 1 with the touch sensor. In FIG. 6, Part A illustrates the waveform of the common signal Vcom, Part B illustrates the waveform of the selector signal SEL1, Part C illustrates the waveform of the read signal RD, Part D illustrates the waveform of the signal Gate(n) of the gate line GCL, Part E illustrates the waveform of the signal line voltage Vsig of the signal line SGL, and Part F illustrates the waveform of the pixel voltage Vpix(n). FIG. 6 illustrates the operational examples of the display device 1 with the touch sensor in the various touch states in the period from the timing t11 to the timing t15 of FIG. 5. In other words, the various touch states include the state where the touch is not made (non-touch state), the state where the pressing force is weak (weak touch state), and the state where the pressing force is strong (strong touch state).

First, the non-touch state and the weak touch state will be described.

In the non-touch state, the touch is not made onto the display section 10 with the built-in touch sensor. In this state, the distance between the pixel electrode 112 (the sensor electrode 114) and the common electrode 123 in FIG. 3 is maintained by the spacer 115. Meanwhile, in the weak touch state, the distance between the pixel electrode 112 (the sensor electrode 114) and the common electrode 123 is slightly narrowed by the weak pressing force onto the display section 10 with the built-in touch sensor, in comparison with the non-touch state. In other words, in the weak touch state, the liquid crystal capacity Clc is larger in comparison with that of the non-touch state.

By this difference of the liquid crystal capacity Clc, as illustrated in Part E and Part F of FIG. 6, the touch voltage Vtouch in the touch detection period T3 is different. In other words, the touch voltage Vtouch in the non-touch state is a voltage V0, but the touch voltage Vtouch in the weak touch state is a voltage V1 which is higher than the voltage V0 in the non-touch state. By using the equation 1, the voltage V0 and the voltage V1 are represented by the following equations.

$$\begin{matrix}Equation 2 & \\ V 0 = \frac{( {C}_{pix} + {C}_{l c} 0 ) \times {V}_{p} + {C}_{gig} \times {V}_{s}}{{C}_{sig} + {C}_{pix} + {C}_{lc} 0} & ( 2 ) \\ Equation 3 & \\ V 1 = \frac{( {C}_{pix} + {C}_{lc} 0 + Δ C ) \times {V}_{p} + {C}_{sig} \times {V}_{s}}{{C}_{sig} + {C}_{pix} + {C}_{lc} 0 + Δ C} & ( 3 )\end{matrix}$$

Here, Clc0 represents the liquid crystal capacity Clc in the non-touch state, and Clc0+ΔC represents the liquid crystal capacity Clc in the weak touch state. In other words, ΔC represents the change amount (increase amount) of the liquid crystal capacity Clc from the liquid crystal capacity Clc0 caused by the weak pressing force in the weak touch state.

By calculating the equation 3−the equation 2, a potential difference ΔV (=the voltage V1−the voltage V0) of the touch voltage Vtouch in the weak touch state and the non-touch state is represented as follows.

$$\begin{matrix}Equation 4 & \\ Δ V = \frac{{C}_{sig}}{( {C}_{sig} + {C}_{pix} + {C}_{lc} 0 ) \cdot ( \frac{{C}_{sig} + {C}_{pix} + {C}_{lc} 0}{Δ C} + 1 )} \times ( {V}_{p} - {V}_{s} ) & ( 4 )\end{matrix}$$

This potential difference ΔV of the touch voltage Vtouch relates to the touch detection sensitivity. In other words, the touch detection sensitivity is improved by increasing the potential difference ΔV. The equation 4 indicates that the potential difference ΔV is proportional to the potential difference (Vp−Vs). In other words, as the potential difference (Vp−Vs) between the pixel voltage Vpix(n) (the voltage Vp) of the pixel electrode 112 on the n^{th} line, and the signal line voltage Vsig (the voltage Vs) of the signal line SGL is large before the timing t13, that is, before the charge transfer occurs between the signal line SGL and the pixel electrode 112 on the n^{th} line, the potential difference ΔV is large, and therefore the touch detection sensitivity is further improved.

As described above, in the display device 1 with the touch sensor, the pixel electrode 112 is precharged by using the inversion common signal xVcom in the horizontal line period immediately previous the horizontal line period in which the precharge of the signal line SGL and the touch detection are performed. Therefore, the voltage Vp before the timing t13 may be set to be high, and the potential difference (Vp−Vs) may be set to be large.

In this manner, by setting the touch detection sensitivity to be high, it is not necessary to provide an amplification circuit for amplifying the touch voltage Vtouch in each pixel PIX. Therefore, the structure of the pixel PIX is simplified, and it may be possible to minimize reduction of the aperture ratio.

As illustrated in FIG. 6, to distinguish the weak touch state and the non-touch state, the reference voltage Vref of the comparator Comp in the touch detection section 22 may be set between the voltage V0 and the voltage V1. Therefore, the touch detection section 22 may determine the presence/absence of the touch by distinguishing the weak touch state and the non-touch state.

Next, the strong touch state will be described.

In the strong touch state, by strongly pressing the display section 10 with the built-in touch sensor, the pixel electrode 112 (the sensor electrode 114) and the common electrode 123 which correspond to the pressed place are in contact with each other. Therefore, as illustrated in Part F of FIG. 6, in the strong touch state, the pixel voltage Vpix(n) is the same voltage as the common voltage Vcom. In the timing t13, when the vertical drive section 24 changes the gate line signal Gate(n) from the low level to the high level (Part D of FIG. 6), and the pixel voltage Vpix is transmitted to the pixel transistor PixTr when the pixel transistor PixTr is in the On state, the signal line voltage Vsig is the same voltage as the common voltage Vcom (Part E of FIG. 6).

Thus, as illustrated in FIG. 6, to distinguish the strong touch state and the non-touch state, the above-described reference voltage Vref used for distinguishing the weak touch state and the non-touch state may be used as it is.

(Effects)

As described above, in this embodiment, because the touch is detected based on the change of the capacitance between the pixel electrode and the common electrode of the liquid crystal display device, and before the touch detection is performed, the signal line and the pixel electrode are initialized so that the potential difference between the voltage of the signal line and the voltage of the pixel electrode is increased, it may be possible to improve the touch detection sensitivity without providing an amplification unit in each pixel.

Further, in this embodiment, because the pixel electrode is precharged by using the signal line precharge for display performed in the horizontal line period immediately previous the horizontal line period in which the touch detection is performed, it may be possible to realize the precharge of the pixel electrode with the simple controlling method without a special control for precharging the pixel electrode.

Modification 1-1

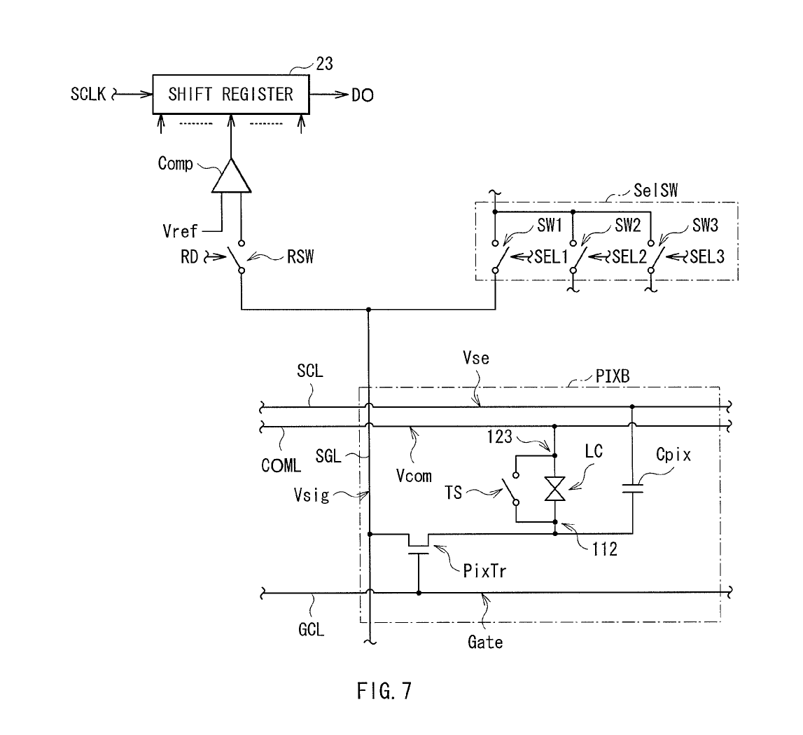

In the above-described embodiment, although the display section 10 with the built-in touch sensor is constituted of the minimum-necessary elements and the minimum-necessary wirings as illustrated in FIG. 2, the disclosure is not limited thereto. In substitution for this, for example, as illustrated in FIG. 7, the display section 10 with the built-in touch sensor may be constituted by adding a sensor control line SCL.

Although the one end of the pixel capacity Cpix is connected to the common signal line COML in FIG. 2, in substitution for this, the one end of the pixel capacity Cpix is connected to the sensor control line SCL in FIG. 7. A sensor control line signal Vse is supplied to the sensor control line SCL. The sensor control line signal Vse has the same waveform as the common signal Vcom, and the voltage amplitude of the sensor control line signal Vse is larger than that of the common signal Vcom.

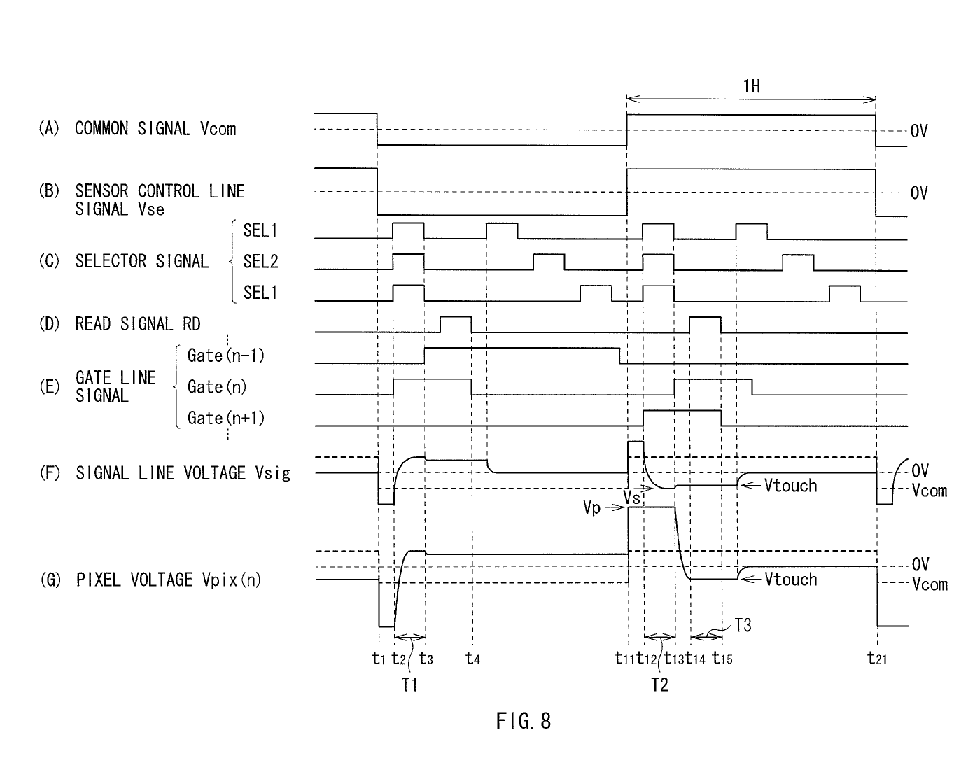

FIG. 8 illustrates the timing waveform diagrams of the display operation and the touch detection operation of the display device with the touch sensor according to this modification, and illustrates the state where the touch is made. In FIG. 8, Part A illustrates the waveform of the common signal Vcom, Part B illustrates the waveform of the sensor control line signal Vse, Part C illustrates the waveforms of the selector signals SEL1 to SEL3, Part D illustrates the waveform of the read signal RD, Part E illustrates the waveform of the signal Gate of the gate line GCL, Part F illustrates the waveform of the signal line voltage Vsig of the signal line SGL, and Part G illustrates the waveform of the pixel voltage Vpix.

In the display device with the touch sensor according to this modification, because the sensor control line signal Vse having the voltage amplitude larger than that of the common signal Vcom is supplied to the pixel capacity Cpix, the voltage change amount of the pixel voltage Vpix(n) in the timings t1, t11, and t21 is larger (Part G of FIG. 8) in comparison with the case of the display device 1 with the touch sensor according to the first embodiment (Part F of FIG. 5). Therefore, the voltage Vp in the timing t13 is high, and from calculation of the equation 4, the potential difference ΔV (=the voltage V1−the voltage V0) of the touch voltage Vtouch may be increased. As a result, the touch detection sensitivity may be further improved.

### 2. Second Embodiment

Next, the display device with the touch sensor according to a second embodiment of the present disclosure will be described. In this embodiment, the method of driving the gate line GCL by the vertical drive section 24 is different from the driving method of the first embodiment. In other words, in the first embodiment, although the vertical drive section 24 activates the gate line signal Gate to the one gate line GCL in the period other than the pixel electrode precharge period in each horizontal line (1H) period, in a display device 1B with a touch sensor of this embodiment, the vertical drive section 24 activates the gate line signal Gate to the two or more gate lines GCL. The circuit structure of the display device 1B with the touch sensor of this embodiment is the same as that of the first embodiment (FIGS. 1 and 2), and the vertical drive section 24 drives the gate line GCL as described above. Other operations are the same as those of the first embodiment (FIG. 5). In addition, same reference numerals will be used for components substantially identical to those of the display device with the touch sensor according to the first embodiment, and the description will be appropriately omitted.

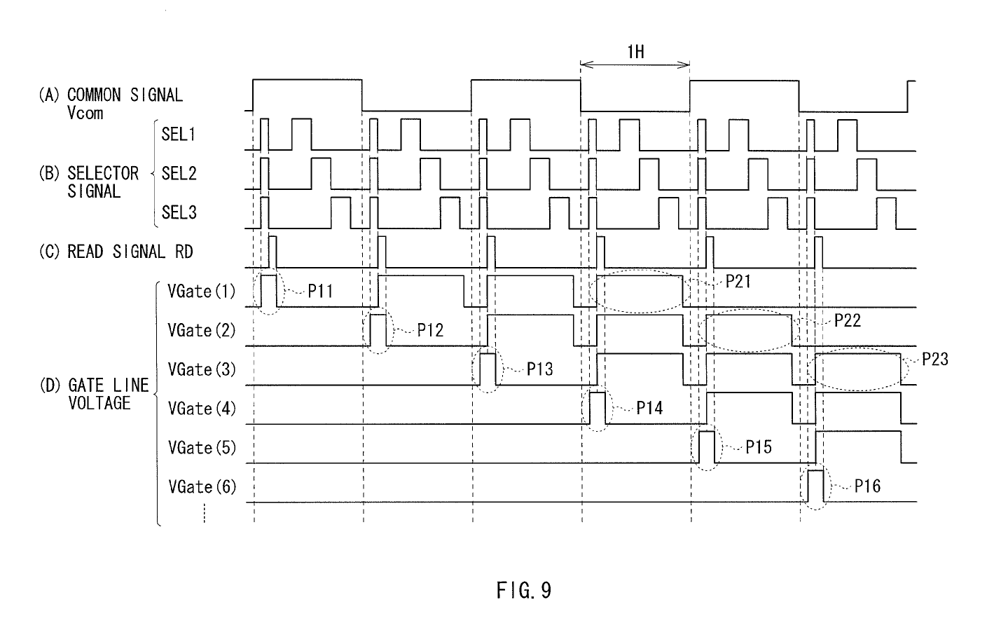

FIG. 9 illustrates the timing waveform diagrams of the display operation and the touch detection operation of the display device 1B with the touch sensor. In FIG. 9, Part A illustrates the waveform of the common signal Vcom, Part B illustrates the waveforms of the selector signals SELL to SEL3, Part C illustrates the waveform of the read signal RD, and Part D illustrates the waveforms of the signals Gate of the gate lines GCL. In this example, in each horizontal line period, the vertical drive section 24 activates the gate line signal Gate to the three gate lines GCL at the same time.

As illustrated in FIG. 9, in the display device 1B with the touch sensor, the gate line signal Gate is activated to the plurality of gate lines GCL at the same time, and the plurality of touch sensors TS connected to the same signal line SGL output the touch voltage Vtouch to the signal line SGL at the same time. As an example, the description will be specifically made while focusing on the pixel PIX on the third line.

First, the vertical drive section 24 outputs a pulse P13 as a gate line signal Gate(3) (Part D of FIG. 9), and the display drive section 21 performs the pixel electrode precharge on the pixel electrode 112 of the pixel PIX on the third line. In the next horizontal line period, the control section 25 changes all of the selector signals SEL1 to SEL3 to the high level at the same time (Part B of FIG. 9), and the display drive section 21 performs the signal line precharge on the signal line SGL. Thereafter, the control section 25 changes all of the selector signals SEL1 to SEL3 to the low level at the same time, the vertical drive section 24 changes the gate line signal Gate(3) from the low level to the high level (Part D of FIG. 9), and the touch voltage Vtouch is generated by the charge transfer between the signal line SGL and the pixel electrode.

At this time, when the vertical drive section 24 changes the gate line signal Gate(3) from the low level to the high level, the vertical drive section 24 also changes gate line signals Gate(1) and Gate(2) from the low level to the high level (part D of FIG. 9). Therefore, all of the pixel transistors PixTr of the pixels PIX on the first line to the third line connected to the same signal line SGL are ON, and the charge transfer occurs between the signal line SGL and the pixel electrodes 112 of the pixels PIX on the first line to the third line.

Generally, in the case where the finger or the like presses the touch panel, the liquid crystal capacity Clc is changed over the plurality of the pixels PIX corresponding to the size of the finger. Therefore, as described above, by the charge transfer between the signal line SGL and the pixel electrodes of the plurality of pixels PIX, the change amount ΔC of the liquid crystal capacity Clc is increased correspondingly, and the potential difference ΔV (=the voltage V1−the voltage V0) of the touch voltage Vtouch in the weak touch state and the non-touch state is increased. In this manner, by increasing the potential difference ΔV, it may be possible to improve the touch detection sensitivity.

The potential difference ΔV of the touch voltage Vtouch when the gate line signal Gate is activated to the plurality of gate lines GCL is represented by the following equation.

$$\begin{matrix}Equation 5 & \\ Δ V = \frac{n \cdot {C}_{sig} \cdot Δ C}{\{ {C}_{sig} + n \cdot ( {C}_{pix} + {C}_{l c} 0 ) \} \cdot \{ {C}_{sig} + n \cdot ( {C}_{pix} + {C}_{lc} 0 + Δ C ) \}} \cdot ( {V}_{p} - {V}_{s} ) & ( 5 )\end{matrix}$$

Here, “n” is the number (the number of gate lines driven at the same time) of the gate lines GCL to which the gate line signals Gate are activated.

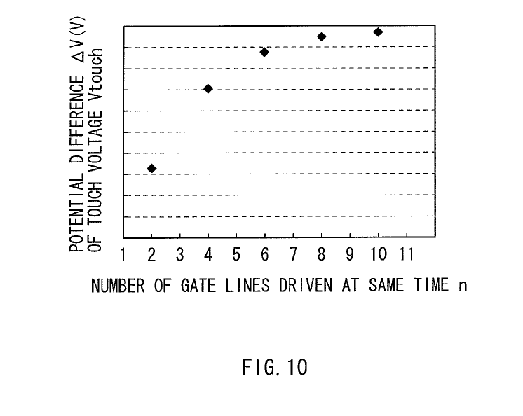

FIG. 10 illustrates a plot diagram of a simulation result of the relationship between the number of the gate lines driven at the same time “n”, and the potential difference ΔV of the touch voltage Vtouch. The first embodiment (FIG. 5) corresponds to the case where the number, of the gate lines driven at the same time “n”=1, and the example of this embodiment (FIG. 9) corresponds to the case where the number of the gate lines driven at the same time “n”=3. As illustrated in FIG. 10, the potential difference ΔV of the touch voltage Vtouch is increased, as the number of the gate lines driven at the same time “n” is increased. In other words, by increasing the number of the gate lines driven at the same time “n”, it may be possible to improve the touch detection sensitivity.

In the display operation, the display performed in the last horizontal line period in the plurality of successive horizontal line periods in which the vertical drive section 24 activates the gate line signal Gate is held for the subsequent one frame period. Specifically, for example, in the pixel PIX on the third line, the display performed when the vertical drive section 24 outputs a pulse P23 as the gate line signal Gate(3) is held for the subsequent one frame period.

As described above, in this embodiment, because the plurality of gate lines GCL are driven at the same time, and the plurality of touch sensors TS output the touch voltage Vtouch at the same time, the potential difference ΔV of the touch voltage Vtouch in the weak touch state and the non-touch state may be increased, and the touch detection sensitivity may be improved. Other effects are the same as those of the first embodiment.

### 3. Third Embodiment

Next, the display device with the touch sensor according to a third embodiment of the present disclosure will be described. In this embodiment, the touch sensor TS as a dummy is provided outside a touch detection region, and the reference voltage Vref of the comparator in the touch detection section is obtained based on the touch voltage Vtouch output by that touch sensor TS. Other operations are the same as those of the first embodiment (FIG. 5), and those of the second embodiment (FIG. 9). In addition, same reference numerals will be used for components substantially identical to those of the display device with the touch sensor according to the first embodiment and the second embodiment, and the description will be appropriately omitted.

FIG. 11 illustrates a structural example of a display device 1C with a touch sensor according to this embodiment. The display device 1C with the touch sensor includes a display section 10C with a built-in touch sensor having a dummy sensor section 17, and a touch detection section 21C.

The dummy sensor section 17 is arranged outside the touch detection region (an effective display region 16) which may be pressed by the external proximity object. In other words, for example, by arranging a hard cover on the surface of the color filter substrate 12 in FIG. 3, the color filter substrate 12 corresponding to the dummy sensor section 17 is not deflected by the external proximity object. The dummy sensor section 17 includes the pixel PIX and the signal line SGL which have the same structures as those used in the effective display region 16. In a vertical blanking period, the pixel PIX of the dummy sensor section 17 is driven by the display drive section 21 and the vertical drive section 24 in the same manner as the pixel PIX of the effective display region 16. In other words, after the pixel electrode and the signal line are precharged, the touch sensor TS of the pixel PIX in the dummy sensor section 17 outputs the touch voltage Vtouch. This touch voltage Vtouch output by the touch sensor TS of the dummy sensor section 17 corresponds to the touch voltage Vtouch (the voltage V0) output by the pixel PIX of the effective display region 16 in the non-touch state.

The touch sensor TS in the pixel PIX of the dummy sensor section 17 corresponds to a specific example of “dummy touch detection element” in the present disclosure. The signal line SGL of the dummy sensor section 17 corresponds to a specific example of “dummy signal line” in the present disclosure.

Based on the touch voltage Vtouch (the voltage V0) supplied from the dummy sensor section 17, the touch detection section 21C obtains the reference voltage Vref used for the touch detection performed on the effective display region 16.

The reference voltage Vref of the comparator Comp in the touch detection section is changed according to a variation caused by an individual difference of the display device with the touch sensor, and environmental conditions such as temperature. In other words, for example, in FIG. 3, the distance between the pixel electrode 112 (the sensor electrode 114) and the common electrode 123 is changed according to the variation in the manufacture and the environmental conditions such as the temperature. Therefore, because the liquid crystal capacity Clc is also changed, as represented by the equation 2 and the equation 3, the voltage V1 of the touch voltage Vtouch in the weak touch state, and the voltage V0 in the non-touch state are also changed. Therefore, it is also necessary to change the reference voltage Vref of the comparator Comp so as to correspond to these changes.

In this embodiment, the reference voltage Vref is obtained based on the touch voltage Vtouch (the voltage V0) supplied from the dummy sensor section 17, and this reference voltage Vref is used for the touch detection performed on the effective display region 16. Therefore, it may be possible to perform the stable touch detection operation without depending on the variation caused by the individual difference, and the environmental conditions such as the temperature.

As described above, in this embodiment, because the dummy sensor section 17 is provided, and the reference voltage Vref for the touch detection in the touch detection section is obtained based on the touch voltage supplied from the dummy sensor section 17, it may be possible to perform the stable touch detection operation without depending on the variation caused by the individual difference, and the environmental conditions such as the temperature. Other effects are the same as the case of the first embodiment.

In the above-described embodiment, although the dummy sensor section 17 is arranged in such a manner that the pixels PIX are arranged to constitute a column on one side of the display section with the built-in touch sensor, the disclosure is not limited thereto. For example, the dummy sensor section 17 may be arranged in such a manner that the pixels PIX are arranged to constitute the columns on both sides of the display section with the built-in touch sensor. Further, for example, the dummy sensor section 17 may be arranged in such a manner that the pixels PIX are arranged to constitute a row on the one side of the display section with the built-in touch sensor, or may be arranged in such a manner that the pixels PIX are arranged to constitute the rows on the both sides of the display section with the built-in touch sensor. Further, when the pixels PIX constitute the row and the column, the number of the pixels PIX may be smaller than the number of the pixels PIX constituting the row and the column in the effective display region 16. Further, for example, the pixels PIX of the dummy sensor section 17 may be arranged at four corners of the display section with the built-in touch sensor.

In the above-described embodiment, although the dummy sensor section 17 is driven in the vertical blanking period, the disclosure is not limited thereto. For example, the dummy sensor section 17 may be driven in the period in which the display operation and the touch detection operation are performed in the effective display region.

### APPLICATION EXAMPLES

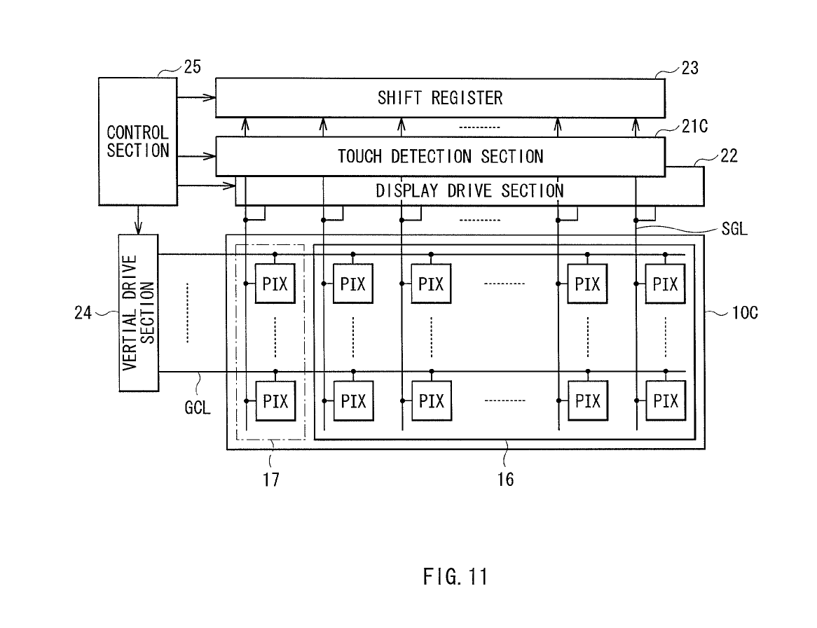

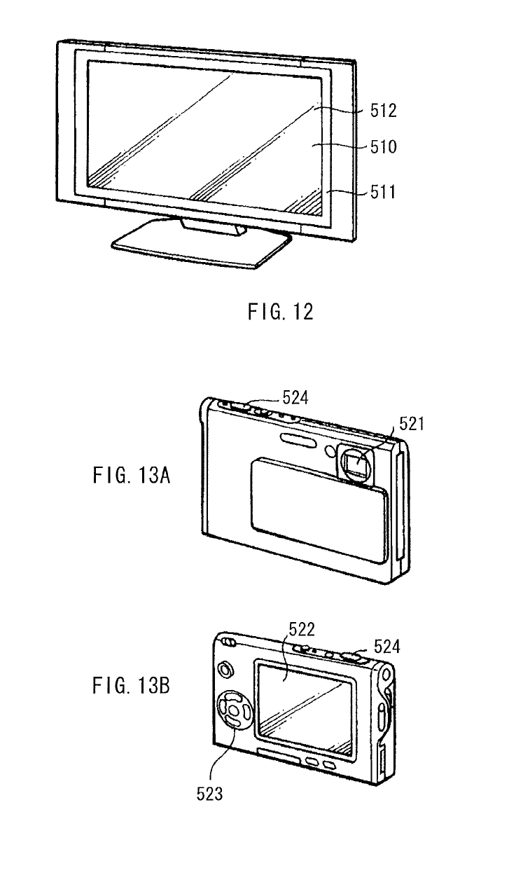

Next, with reference to FIGS. 12, 13A to 13B, 14, 15A to 15B, and 16A to 16G, a description will be made on application examples of the display device with the touch sensor described in the above-described embodiments and the modification. The display device with the touch sensor of the above-described embodiments and the like are applicable to electronic units in various fields, such as a television device, a digital camera, a notebook personal computer, a mobile terminal device such as a mobile phone, and a video camera. In other words, the display device with the touch sensor of the above-described embodiments and the like is applicable to the electronic units in the various fields, in which a video signal input from outside, or a video signal generated inside the display device is displayed as an image or a video.

### First Application Example

FIG. 12 illustrates an appearance of a television device to which the display device with the touch sensor of the above-described embodiments and the like is applied. The television device includes, for example, a video display screen section 510 including a front panel 511 and a filter glass 521. The video display screen section 510 is constituted of the display device with the touch sensor of the above-described embodiments and the like.

### Second Application Example

FIGS. 13A and 13B illustrate an appearance of a digital camera to which the display device with the touch sensor of the above-described embodiments and the like is applied. The digital camera includes, for example, a light emitting section 521 for a flash, a display section 522, a menu switch 523, and a shutter button 524. The display section 522 is constituted of the display device with the touch sensor of the above-described embodiments and the like.

### Third Application Example

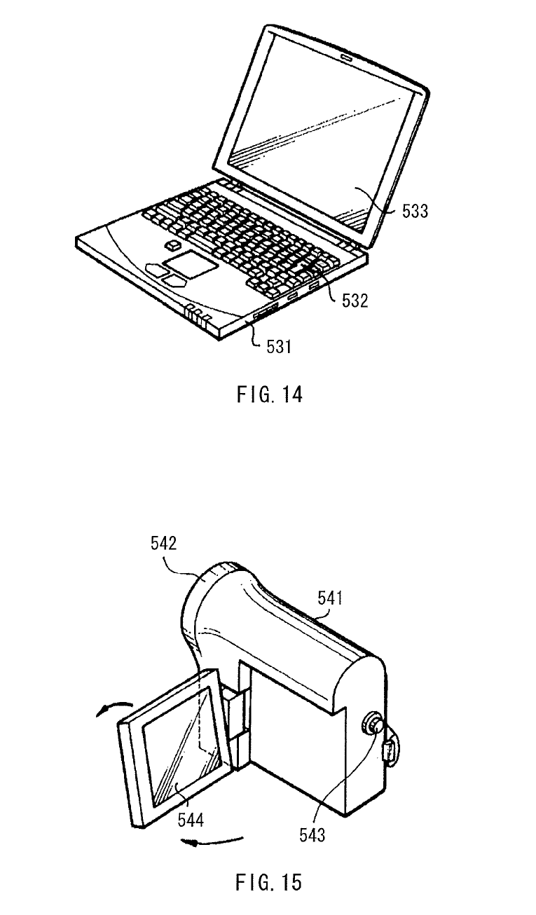

FIG. 14 illustrates an appearance of a notebook personal computer to which the display device with the touch sensor of the above-described embodiment and the like is applied. The notebook personal computer includes, for example, a main body 531, a keyboard 532 for operation of inputting characters and the like, and a display section 533 for displaying an image. The display section 533 is constituted of the display device with the touch sensor of the above-described embodiments and the like.

### Fourth Application Example

FIG. 15 illustrates an appearance of a video camera to which the display device with the touch sensor of the above-described embodiments and the like is applied. The video camera includes, for example, a main body 541, a lens 542 for capturing an object provided on the front side face of the main body 541, a start/stop switch 543 in capturing, and a display section 544. The display section 544 is constituted of the display device with the touch sensor of the above-described embodiments and the like.

### Fifth Application Example

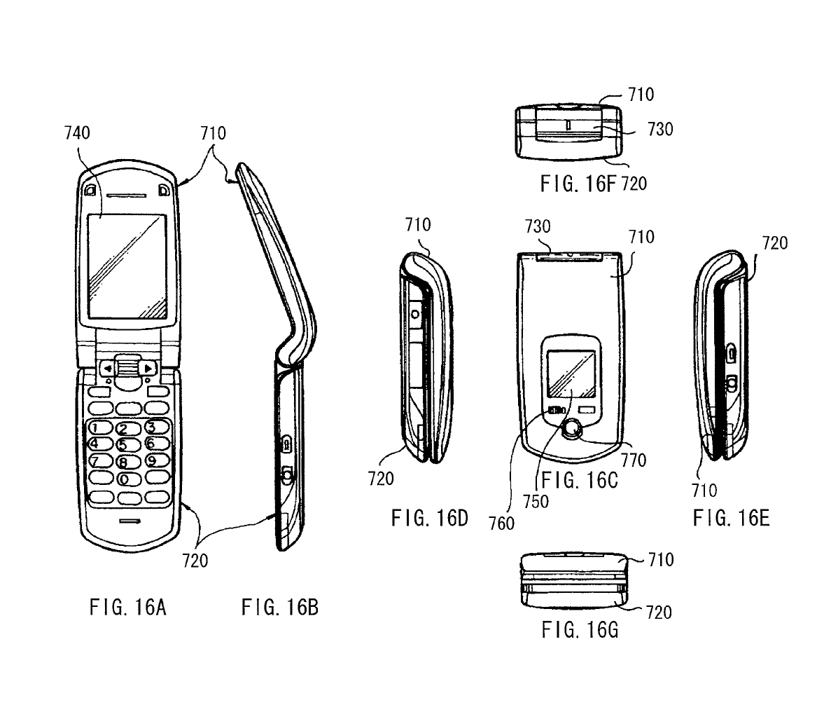

FIGS. 16A to 16G illustrate an appearance of a mobile phone to which the display device with the touch sensor of the above-described embodiments and the like is applied. In the mobile phone, for example, an upper package 710 and a lower package 720 are joined by a joint section (hinge section) 730. The mobile phone, includes a display 740, a sub-display 750, a picture light 760, and a camera 770. The display 740 or the sub-display 750 is constituted of the display device with the touch sensor of the above-described embodiments and the like.

Hereinbefore, although the present disclosure has been described with the several embodiments, the modification, and the application examples to the electronic units, the present disclosure is not limited to the embodiments and the like, and various modifications may be made.

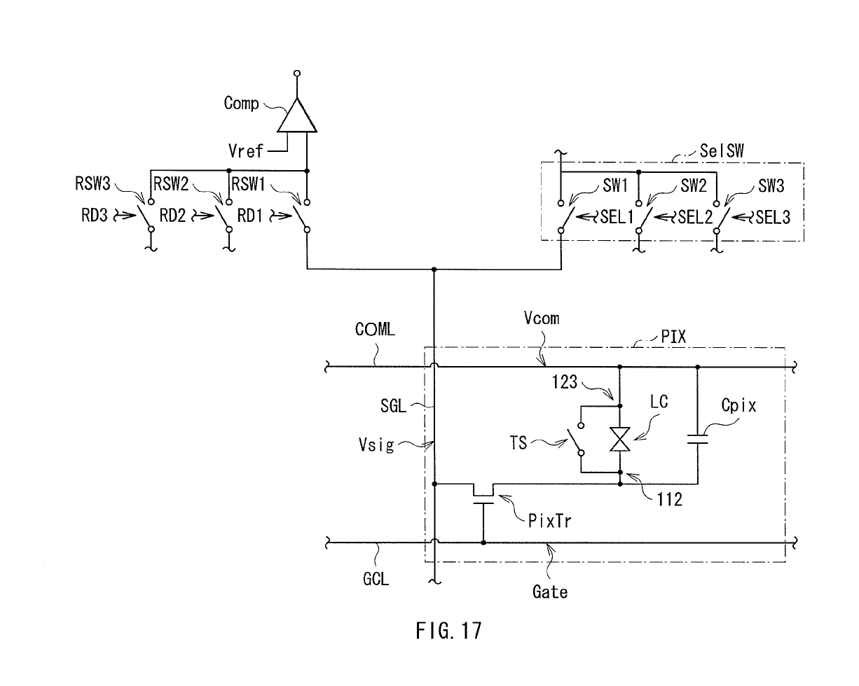

For example, in each embodiment, although the one comparator Comp is connected to the one signal line SGL, respectively, the disclosure is not limited thereto. For example, the one comparator Comp is connected to the plurality of signal lines SGL, and the comparator Comp may be time-divisionally used. FIG. 17 illustrates a structural example of the main part of the display device with the touch sensor according to this modification. The display device with the touch sensor according to this modification includes read switches RSW1 to RSW3. The read switches RSW1 to RSW3 are time-divisionally controlled to turn on/off by read signals RD1 to RD3, and time-divisionally supply the touch voltage Vtouch, which is supplied from the three signal lines SGL, to the comparator Comp. In this manner, by connecting the one comparator Comp to the plurality of signal lines SGL, it may be possible to reduce the number of the comparators Comp in the touch detection section 22.

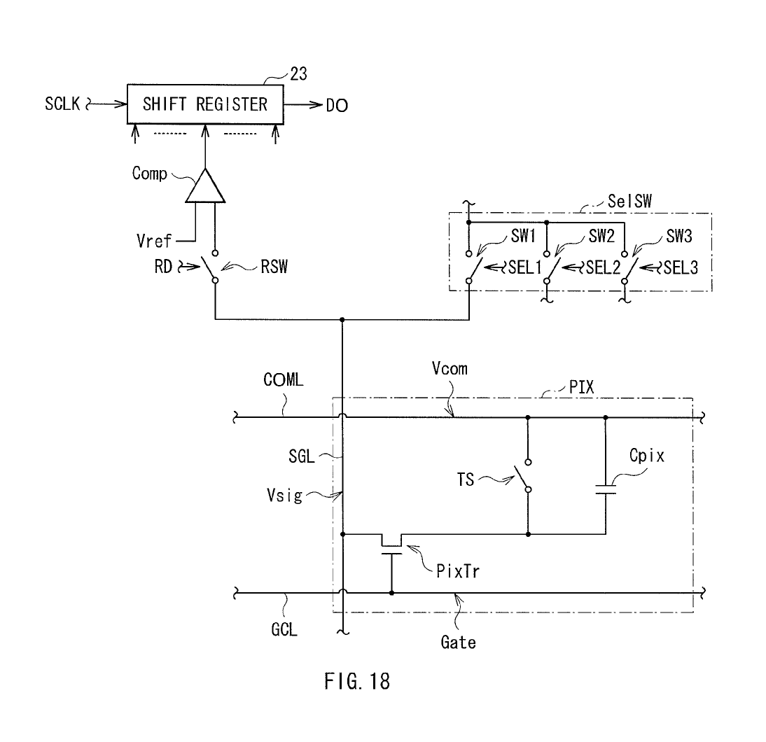

For example, in each embodiment, although the touch sensor is incorporated in the display device, and the display device is constituted as the display device with the touch sensor, the disclosure is not limited thereto. For example, a touch panel may be constituted by using the touch sensor. FIG. 18 illustrates a structural example of a main part of the touch panel according to this modification. In the touch panel illustrated in FIG. 18, the liquid crystal element LC is omitted from the display device with the touch sensor (FIG. 2) of the first embodiment and the like. Specifically, for example, in FIG. 3, this touch panel may be constituted by omitting the liquid crystal of the liquid crystal layer 13. In FIG. 18, the selector switch SelSW is used for supplying the precharge voltage for the touch detection operation to the pixel PIX.

For example, in the second embodiment and the third embodiment, the display section with the built-in touch sensor may be constituted by adding the sensor control line SCL in the same manner as the first embodiment.

It should be understood that various changes and modifications to the presently preferred example embodiments described herein will be apparent to those skilled in the art. Such changes and modifications can be made without departing from the spirit and scope and without diminishing its intended advantages. It is therefore intended that such changes and modifications be covered by the appended claims.

1. A display device comprising:
a drive control section;
a signal line operatively coupled to the drive control section, the signal line having a first voltage; and
a display section operatively coupled to the drive control section, the display section including: (a) a touch detection element configured to output a touch voltage; and (b) an electrode having a second voltage;
wherein the drive control section is configured to, before the touch detection element outputs the touch voltage, increase a potential difference between: (i) the first voltage of the signal line; and (ii) the second voltage of the electrode.

2. The display device of claim 1, wherein the touch voltage is defined based on the potential difference.

3. The display device of claim 1, wherein the potential difference corresponds to touch detection sensitivity.

4. The display device of claim 1, wherein the display section includes a sensor column having a portion, the electrode being configured to cover the portion of the sensor column.

5. The display device of claim 4, wherein the sensor column is formed on one of a first substrate and a second substrate, the second substrate being arranged to face the first substrate.

6. The display device of claim 1, wherein the touch voltage corresponds to a stressing force of an external proximity object.

7. The display device of claim 1, wherein the drive control section is configured to, for a first initialization, supply a first precharge voltage to the electrode, the supplied first precharge voltage being based on a first level of an inversion common signal.

8. The display device of claim 7, wherein the drive control section is configured to, for a second initialization, supply a second precharge voltage to the signal line, the supplied second precharge voltage being based on a second level of the inversion common signal.

9. The display device of claim 7, wherein the first initialization is performed before the display section performs a display operation.

10. The display device of claim 8, wherein the second initialization is performed before the display section performs a display operation.

11. The display device of claim 7, wherein the first initialization is performed in synchronization with the first level of the inversion common signal.

12. The display device of claim 8, wherein the second initialization is performed in synchronization with the second level of the inversion common signal.

13. The display device of claim 1, which includes a liquid crystal element operatively coupled to a common signal line which supplies a common signal for a display operation.

14. The display device of claim 13, which includes a capacitor operatively connected to the liquid crystal element, the capacitor being supplied with the common signal.

15. The display device of claim 13, which includes a sensor control line operatively connected to a capacitor, the common signal having a first voltage amplitude, the sensor control line being supplied with a sensor control line signal which has a second voltage amplitude, the second amplitude voltage being larger than the first voltage amplitude.

16. The display device of claim 1, wherein the drive control section is configured to activate a gate line signal to at least two gate lines, the at least two gate lines being activated at the same time, the at least two gate lines being operatively coupled to the drive control section.

17. The display device of claim 1, which includes:
(a) a dummy touch detection element located outside a touch detection region, the dummy touch detection element being configured to supply a reference voltage; and
(b) a dummy signal line operatively coupled to the drive control section.

18. A method of operating a display device, the method comprising:
causing a drive control section to, before a touch detection element of a display section outputs a touch voltage, increase a potential difference between: (i) a first voltage of a signal line; and (ii) a second voltage of an electrode of the display section.

19. A touch panel comprising:
a drive control section;
a signal line operatively coupled to the drive control section, the signal line having a first voltage;
an electrode operatively coupled to the drive control section, the electrode having a second voltage; and
a touch detection element configured to output a touch voltage;
wherein the drive control section is configured to, before the touch detection element outputs the touch voltage, increase a potential difference between: (i) the first voltage of the signal line; and (ii) the second voltage of the electrode.
